(19) United States
(12) Patent Application Publication
(10) Pub. No.: US 2024/0324807 A1
(43) Pub. Date: Oct. 3, 2024

(54) SYSTEM WITH PRESSURE COOKER AND METHOD

(71) Applicant: Vorwerk & Co. Interholding GmbH, Wuppertal (DE)

(72) Inventors: Sebastian Tietz, Leverkusen (DE); Kevin Schmitz, Haan (DE); Maria Dörner, Köln (DE)

(21) Appl. No.: 18/516,340

(22) Filed: Nov. 21, 2023

(30) Foreign Application Priority Data
Dec. 5, 2022 (EP) 22211416.7

(51) Int. Cl. A47J 27/08; A47J 27/09; A47J 36/32

(52) U.S. Cl. CPC A47J 27/0802; A47J 36/32; A47J 27/09

(57) ABSTRACT

The present disclosure relates to a system and a method with a kitchen appliance for preparing a food product. The system comprises a control device and a device for selecting a preparation time for food products. The control device is configured such that it is able to control the preparation of a food product such that a selected preparation time is observed. The kitchen appliance may comprise a pressure cooker.

By means of the present disclosure, a desired time for the preparation of a food product can be observed.

### PRIORITY CLAIM

This application claims priority to European Application Serial No. 22211416.7 filed Dec. 5, 2022, which is expressly incorporated by reference herein.

### FIELD OF THE DISCLOSURE

The present disclosure relates to a system with a kitchen appliance for the preparation of food products. The system comprises a control device for controlling the preparation of food products by the kitchen appliance. The kitchen appliance may be a pressure cooker or comprise a pressure cooker.

### BACKGROUND

In order to prepare food products in a pressure cooker, a pressure cooker can be heated with the aid of cooking tables, for example using a hob, and removed from the hob at a defined time.

The publication DE 10 2008 051 265 A1 relates to a control device for a pressure cooker, which comprises a sensor device. By means of the sensor device, a parameter that influences the cooking process can be measured. The preparation of food products can be optimized by means of the control device.

The publication DE 197 00 602 A1 discloses a pressure vessel with an electronic monitoring device for the preparation of food products.

It is the task of the present disclosure to be able to prepare food products in a flexible manner.

### SUMMARY

The system of the present disclosure comprises a kitchen appliance with which a food product can be prepared. The kitchen appliance may comprise a preparation vessel or a preparation space. If a food product is to be prepared by means of such a kitchen appliance, the food product is brought into the preparation vessel or into the preparation space. In the preparation vessel or in the preparation space, the food product is processed. Processing may comprise mixing, chopping, and/or temperature control. The kitchen appliance may comprise a heating device for heating a food product brought into the preparation vessel or the preparation space.

A kitchen appliance which serves for food preparation may be, for example, a food processor, a hob with a preparation vessel located on the hob, an oven, a steamer, a deep fryer, or a microwave oven.

A food product can be eaten by a living being in order to nourish the living being. For example, the kitchen appliance can be used to prepare food products such as goulash, boiled beef, chicken, pot roast, vegetables, or potatoes.

The system comprises a control device. A control device is an electronic device by means of which operations can be electronically controlled. A control device may comprise a processor, a microcontroller, and electronic memory modules.

The control device may be integrated into the kitchen appliance. The control device may be separate from the kitchen appliance. The control device may be integrated into another kitchen appliance, into a mobile device, or into the cloud. By cloud, it is meant that the database is provided in such a way that it can be accessed via the Internet. For providing, one or more memory locations and one or more computers along with software can be used. Memory locations and computers may be spatially separated.

The system may comprise a device for selecting a preparation time for food products. The device may comprise, for example, a keyboard, a microphone together with a voice recognition device, a display or one or more switches, knobs and/or sliders. The display may be a touch-sensitive display.

By preparation time is meant a time to be spent for the preparation of a food product. For example, a time may be set such as 12:00. Then, the food product is to be prepared by the kitchen appliance at 12:00. For example, a time period can be set such as 30 minutes. Then the food product is to be prepared by the kitchen appliance after 30 minutes. The device for selecting a preparation time may be configured such that it provides possible times from which to select. For example, the device for selecting a preparation time can specify that a food product can be prepared between 11:30 and 12:30. A time between 11:30 and 12:30 may then be freely selected. For example, the device for selecting a preparation time may specify that a food product can be prepared within 20 minutes to 60 minutes. A time period of 20 minutes to 60 minutes can then be freely selected.

The control device is configured such that it can control the preparation of the food product such that a selected preparation time is observed (met). For example, if 12:00 is selected, then the food product is prepared such that preparation by the kitchen appliance is completed at 12:00. If, for example, 30 minutes has been selected, then the food product is prepared in such a way that preparation by the kitchen appliance is completed 30 minutes later after a start of preparation. By preparation it is meant that a desired same or at least substantially same state of the food product has been achieved through preparation, regardless of the duration of a selected prepare time. Thus, the state of a food product after the end of the preparation does not depend on whether the preparation took 30 minutes or 40 minutes.

The system of the present disclosure allows a user to set the duration for preparing food products at least within certain limits. For example, guests are late and the food should not be overcooked, but it should also not get cold. A time may then be set so that food products of the food are suitably prepared later, despite the guests being late.

The system may be configured such that it is specialized for preparing specific food products. In such a case, it is not necessary that the control device has been informed which food product is to be prepared in order to control the preparation in dependence on a food product. If, for example, only one specific food product is ever prepared by a kitchen appliance, then one program of the control device is sufficient to be able to complete a food product at a selected time.

The system may comprise a device for inputting food products. The device for inputting food products may comprise, for example, a keyboard, a microphone together with a voice recognition device, a display or one or more switches, knobs and/or sliders. The display may be a touch-sensitive display. A user may communicate a food product to be prepared to the system via the device for inputting food products. The device for inputting food products may display a list of food products, for example on a screen, for example following an activation. A user may then select a food product from the list and, thus, select the food product to be prepared by the kitchen appliance. However, a user may also be able to type in the name of a food product, for example, using a keyboard. An input may be made via a selection of a recipe.

The system may comprise a database with electronically stored information about cooking times of food products as a function of temperature and/or quantity for controlling the preparation of the food product by the kitchen appliance. The control device can then select the input food product from the database and control the preparation based on the information electronically stored in the database. The system is then able to control the preparation for different food products such that the selected preparation time can be met. The database may be integrated into the kitchen appliance or into another appliance. The database may be provided via cloud.

Controlling the preparation of a food product by the control device may comprise issuing an instruction to a user. This applies in particular to activities that can only be performed in a fully automated manner with an excessively large technical effort. Such an instruction may consist, for example, in prompting a user, for example via a display, another visual element and/or acoustically, to remove a food preparation vessel of the kitchen appliance from a base unit of the kitchen appliance provided for heating the food preparation vessel or to otherwise turn off the supply of heat. Controlling the preparation of a food product by the control device may comprise controlling the preparation in an automated manner. Thus, controlling the preparation of a food product may comprise controlling heating of a food product by the kitchen appliance in an automated manner. The base unit may be a hob of a stove. The base unit may be a part of a food processor. For controlling the preparation of a food product, an electronically stored recipe may be provided that can be accessed by the control device.

The kitchen appliance may be a pressure cooker or comprises a pressure cooker. A pressure cooker can prepare a food product at a highly variable time. If required, a food product can be cooked at a low temperature very slowly and thus be prepared in a particularly time-consuming manner. If required, a food product can be prepared with a temperature of more than 110° C., for example, very quickly and, thus, requiring only little time. A pressure cooker therefore makes it possible to select a desired preparation time very variably.

The pressure cooker is a preparation vessel with a lid for a food. The preparation vessel can be closed in a pressure-tight manner by means of the lid. An increased pressure of more than 1.2 bar, for example, can then build up in the preparation vessel. The increased pressure can be up to 2 bar or up to 1.5 bar, for example. The preparation vessel of the pressure cooker may comprise an opening with an outwardly curved rim with bayonet-like recesses. The lid can then pressure-tightly seal the preparation vessel. An annular seal may be located between the lid and the preparation vessel such that an elevated pressure can build up in the preparation vessel. The seal may consist of an elastomer.

Due to the increased pressure, the boiling temperature of water in the pressure cooker can be increased. The maximum possible boiling temperature in the pressure cooker can be up to 120° C., for example. The maximum possible boiling temperature in the pressure cooker should be at least 110° C.

The pressure cooker may comprise a safety valve that opens when an unacceptably high pressure occurs in the pressure cooker. The occurrence of an unacceptably high pressure in the pressure cooker can be prevented by the safety valve. The safety valve can therefore limit the maximum possible pressure in the pressure cooker.

The pressure cooker can comprise a control valve. A pressure in the pressure cooker may be indicated by the control valve. For example, a control valve may comprise a movable pin, the position of which may depend on the pressure in the pressure cooker. The pin may include markings that may become visible as a function of pressure, and thus are able to indicate a pressure prevailing in the pressure cooker. A pressure cooker may be configured such that its lid can only be opened when there is no overpressure in the pressure cooker.

A valve of the pressure cooker may be such that the valve can be opened to relieve overpressure in the pressure cooker.

The pressure cooker may comprise an insert by means of which a food can be prevented from coming into contact with liquid water in the pressure cooker. A food can then be cooked in steam.

A mixing and/or cutting tool may be provided in the pressure cooker. The shaft of the mixing and/or cutting tool may, for example, pass through the bottom of the pressure cooker to enable the mixing and/or cutting tool to be driven by an external motor.

The control device may be configured such that it controls the preparation of a food product such that a food product is initially prepared in the pressure cooker at the maximum possible temperature. At a later time, the pressure cooker is separated from a base unit through which the pressure cooker is heated. In this embodiment of the present disclosure, on the one hand, the food product can be prepared within the desired time. On the other hand, the base unit can be used again with another preparation vessel after removing the pressure cooker. The other preparation vessel may be a preparation vessel that is different from the pressure cooker, i.e., not the same as the pressure cooker. The volume and/or diameter of the other preparation vessel may be different from the volume and/or diameter of the pressure cooker. A heating device of the other preparation vessel may be different from the heating device of the pressure cooker. A tool may be located in the other preparation vessel that the pressure cooker does not have. The other preparation vessel may be such that no overpressure or at least practically no overpressure can build up in the other preparation vessel. The material of the other preparation vessel can be different from the material of the pressure cooker. The use of the base unit for the preparation of food products can thus be optimized. It is also possible, after separating the pressure cooker from the base unit, to let the pressure cooker continue cooking outside the household, for example in the car on the way to friends, etc.

The system may comprise an input device into which can be input how long a food product is to continue cooking in a pressure cooker independently of a base unit. A pre-selection for one or more time periods may be offered via an electronically provided recipe. For example, it may be of interest that a food product should continue cooking in a pressure cooker for as long as possible independently of a base unit. Such a need may consist because a pressure cooker is to be taken to friends or in order to be able to use a base unit for another preparation for as long as possible. If a food product is to continue cooking for as long as possible in a pressure cooker independently of a base unit, the control device basically controls the temperature of the pressure cooker such that it is at a maximum when the pressure cooker is to be separated from the base unit.

The time required to prepare a food product at different temperatures can be stored in a database. The lower the temperature, the more time is required to prepare a food product. A heating and cooling characteristic for the preparation vessel may be stored in the database. The control device may access the data or information stored in the database to calculate how to control a preparation.

If sufficient time is available, the control device can control the preparation in such a way that not only the preparation is completed within a selected time, but that a pressure cooker is then also pressure-free. At the end of a preparation time, there is no longer any overpressure in the pressure cooker. The pressure cooker can then be opened immediately. In some implementations, the preparation is then controlled so that a food product is prepared when the atmospheric pressure is reached again in the pressure cooker. The pressure cooker may be configured such that it can only be opened when atmospheric pressure prevails. This ensures that a user cannot disadvantageously open the pressure cooker before the cooking time has elapsed.

The present disclosure also relates to a method for preparing a food product using a system according to the present disclosure. A preparation time is selected via the device for selecting a preparation time. Subsequently, the control device controls the preparation of the food product such that the selected preparation time is observed (met).

In one embodiment, the system is configured such that a selected preparation time can be changed during a preparation. Thus, the present disclosure also includes a method in which a preparation time is initially selected via the means for selecting a preparation time. After the preparation has started, a different time is selected. Subsequently, the control device controls the preparation of the food product such that the most recently selected preparation time is observed.

In one embodiment of the method, a food product is input by means of the device for inputting a food product. The control device of the system subsequently selects the input food product from the database of electronically stored information on cooking times of food products and thus obtains the associated information. Subsequently, the preparation of the food product is controlled by the control device using the information.

As part of preparing the food product, an instruction for a user may be output visually via a display, another visual element and/or acoustically via a loudspeaker. Such an instruction may consist of turning off the supply of heat to the food product before the end of the cooking time. Such an instruction may consist in removing a preparation vessel of the kitchen appliance from a base unit of the kitchen appliance before the end of the cooking time.

As part of the method, a pressure cooker to which heat is supplied by means of a base unit is can be selected as the kitchen appliance. However, the pressure cooker may also comprise an integrated heater, in which case a base unit need not be present. The heater may be formed by or comprise one or more resistance wires. When electric power flows through a resistance wire, the resistance wire heats up. The heater may be a tube heater, i.e., comprise tubes for heating. In one configuration, the heater may be a thick film heater.

In some implementations, a food product is first prepared in the pressure cooker at the maximum possible temperature. At a later time, the pressure cooker is separated from the base unit before the end of the cooking time such that the base unit can be used for another preparation of a food product using a different preparation vessel. In one embodiment of the method, after the pressure cooker is separated from the base unit, another food product is prepared using a different preparation vessel and the base unit. A user can then use the base unit, for example, to prepare sauces, pastes, desserts, etc.

The present disclosure makes it possible to synchronize the preparation of different food products that are prepared in parallel. For example, a bread has been placed in an oven and a baking time of half an hour has been set. In addition, goulash is to be prepared in the pressure cooker. It is then entered into the system that the goulash should also be ready after 30 minutes. Both food products are then ready at the same time. The present disclosure also includes preparing two different food products in parallel. Two different food products can be prepared in two different preparation vessels.

The present disclosure makes use of the fact that potential energy and thermal energy are stored in a heated pressure cooker, which can be used to cook food products independently of a continuous energy supply. A pressure cooker and its contents are then charged once by an energy source with an initial energy in order to continue cooking passively and independently of the energy source.

In the case of a pressure cooker, particularly good use can be made of the fact that the cooking time is exponentially dependent on the temperature. The pressure cooker may comprise an integrated heater or it is heated indirectly (e.g. by induction).

The present disclosure enables passive further cooking in the preparation vessel in any place and thus wherever there is space in the household, i.e. even outside the kitchen such as in the garden, living room or dining table. Depending on the type of the food product, the weight of the food product and the available cooking time, a strategy can be chosen to cook a food product in a specified time. Various strategies are available for this. Examples of these are explained below with reference to figures. The specified time can either be specified by the user or can be derived from the context of a preparation of a meal (menu) consisting of several prepared food products.

For example, a user wants to prepare a meal. For the preparation, the user has, among other things, the system according to the present disclosure with a kitchen appliance comprising a base unit and a pressure cooker. The base unit is able to heat the pressure cooker. The pressure cooker may comprise integrated resistance heating elements that may be supplied with electricity by the base unit. When electricity is supplied to the resistance heating elements, the pressure cooker is heated. The base unit may further comprise a motor by means of which a mixing and/or cutting tool of a second preparation vessel can be driven. The mixing and/or cutting tool may be located in the second preparation vessel. The shaft of the mixing and/or cutting tool may be rotationally fixed to the shaft of the motor when the second preparation vessel is placed on the base unit. A rotary movement of the shaft of the motor can then be transmitted to the mixing and/or cutting tool. The second preparation vessel may also comprise integrated resistance heating elements which can be supplied with power by the base unit. Thus, the second preparation vessel can also be heated. The base unit may have a recess into which either the pressure cooker or the second preparation vessel can be inserted.

The base unit may comprise a closing mechanism by means of which a lid for the pressure cooker and/or for the second food preparation vessel can be locked. For example, the closing mechanism may comprise two arms that can be pivoted or rotated back and forth between a locking position and an opening position. In the locking position, a lid is pressure-tightly connected to the selected preparation vessel. In the opening position, the lid can be removed from the selected preparation vessel, for example. The lid for the pressure cooker is completely closed. However, it may be preferable that the lid for the pressure cooker can also be connected to the preparation vessel in a pressure-resistant (pressure-tight) manner independently of the closing mechanism. It is then possible to separate the pressure cooker from the base unit at any time after opening the closing mechanism, in order to enable optimized passive further cooking independently of the base unit.

The lid for the second preparation vessel may have an opening through which ingredients can be introduced into the preparation vessel even when the lid is connected to the second preparation vessel. There may be a closure means for the opening, which may act as a splash guard. The closure means may be or comprise a measuring cup.

The meal may be an electronically stored meal with different recipes for preparing different food products such as meat, vegetables and potatoes, which can be accessed by the base unit for semi-automated preparation. The meal can be individually composed by the user.

With the goal of having all food products cooked at the same time, the system can adjust the preparation time of individual food products by varying cooking parameters such as pressure and/or temperature. Whereby the pressure can also be controlled via the temperature, if necessary. The present disclosure allows the base unit to be used multiple times with the different preparation vessels. For example, the base unit can first be used to prepare risotto in the pressure cooker. At a suitable time before the end of the cooking time, the pressure cooker can be separated from the base unit. For example, a salad or punch can then be prepared in the second preparation vessel while the food product finishes cooking in the pressure cooker. Braised dishes such as goulash, boiled beef, whole chicken or pot roast can be prepared. Before the end of the cooking time, the pressure cooker can be separated from the base unit for passive further cooking. During the time of passive further cooking in the pressure cooker, additional side dishes such as potatoes or other kinds of vegetable can be cooked or steamed in a second preparation vessel on the base unit.

It is also possible that the preparation is controlled by the control device in such a way that the preparation comprises passive further cooking, but this is not sufficient for complete preparation due to an excessive temperature drop. The preparation vessel, for example a pressure cooker, must then be reheated. This can be of interest if a base unit is needed in between for the preparation of another food product. For example, chicken or beef is first steamed in the pressure cooker by supplying energy through a base unit. The pressure cooker is separated from the base unit before the end of the cooking time. However, the heat storage capacity of the pressure cooker is not sufficient to finish cooking the food product. The base unit can now be used, for example, to prepare ingredients for a bowl. For example, vegetables can now be chopped. A sauce, for example, can now be prepared. Once the preparation of the ingredients on the base unit is complete, the chicken or beef can now be finished cooking by means of the base unit. The control device can therefore be configured such that it can also control the preparation in such a way that cooking continues passively in between.

The heat storage capacity of a pressure cooker can depend on the amount of water in the pressure cooker for a preparation. The control device may therefore be configured such that it can specify an amount of water to be placed in a pressure cooker. Also by specifying amounts of water, the control device can therefore control or at least influence times for passive further cooking.

For example, a user may not only want to prepare a food, but also to do other activities in parallel, such as mowing the lawn, picking up children or bringing them to sports. The time required for the parallel activity does not correspond to the standard provided preparation time, during which a user may be absent. In this case, by varying cooking parameters such as pressure, temperature, and/or by timing an automated energy cutoff, the system can adjust the preparation time accordingly, such as extending or shortening it. This is possible for individual food products. However, the system can also comprise a plurality of kitchen appliances, so that this is also possible for the preparation of meals. For example, a meal can be prepared that comprises a goulash soup and a risotto.

Monitoring of temperatures in the food preparation vessel of the system can be performed continuously. The food preparation vessel can therefore be configured such that temperature monitoring is still possible even when the food preparation vessel has been separated from its base unit. The food preparation vessel may comprise, for example, a temperature measuring device and a radio unit in order to be able to send measured temperatures at any time at least wirelessly, for example to the control device for the purpose of temperature monitoring. However, continuous temperature monitoring is not necessary. In particular, this can be omitted when the food preparation vessel has been separated from its base unit.

A food product can also be prepared with the system in accordance with a common procedure. If the preparation vessel is a pressure cooker, the pressure and temperature may be at a maximum until the food product has been prepared. In this case, a user may have selected as the preparation time that the food product should be prepared as quickly as possible. Alternatively, the control device may control the preparation to always prepare as fast as possible if no other preparation time has been selected. The end of a cooking time can be signaled by the control device, for example visually via a display and/or acoustically via a loudspeaker, in order to prepare a food product optimally. For example, braised dishes such as goulash or boiled beef can be prepared as quickly as possible in a controlled manner.

If the food product is not suitable for the maximum pressure possible with the pressure cooker, the upper limit for the pressure is specified by the food product. If the user has selected this food product and entered it into the system, the control device controls the pressure accordingly. This control can in turn be based on empirical values which are stored in a database and which the control device can access. In such a case, the control device also helps to prepare a food product optimally in a very reliable manner.

The control device may be configured such that it can change the temperature in the preparation vessel during the course of a preparation. This may happen if the preparation time is changed by a user during preparation. For example, the temperature can be suitably lowered by the control device if a user increases the preparation time during the course of a preparation. The temperature can be suitably increased by the control device if a user shortens the preparation time in the course of a preparation. The control device changes the temperature in the preparation vessel during the course of a preparation either fully automatically or semi-automatically by instructing a user to manually change a heating power. An electronically stored recipe may be provided, which the control device can access to control or change the temperature. Thus, the recipe then includes information about one or more temperatures.

The control device may be configured such that it is able to change the temperature in the preparation vessel in the course of a preparation and, in addition, it is provided by the control device that a preparation vessel is completely separated from a base unit for passive further cooking and/or a heating of the preparation vessel is completely switched off.

The control device may be configured such that it controls the temperature in a preparation vessel such that the boiling temperature of water is not exceeded. This is especially true if the preparation vessel is a pressure cooker. This may be the case, for example, if a user has entered via an input device of the system that a food product is to be prepared in a particularly gentle manner.

### BRIEF DESCRIPTIONS OF THE DRAWINGS

FIG. 1 shows a system with base unit and pressure cooker.

FIG. 2 shows the base unit with a second preparation vessel.

FIG. 3 shows a controlled first temperature curve over time in a pressure cooker.

FIG. 4 shows a controlled second temperature curve over time in a pressure cooker.

FIG. 5 shows a controlled third temperature curve over time in a pressure cooker.

FIG. 6 shows a controlled fourth temperature curve over time in a pressure cooker.

FIG. 7 shows a controlled fifth temperature curve over time in a pressure cooker.

### DETAILED DESCRIPTION

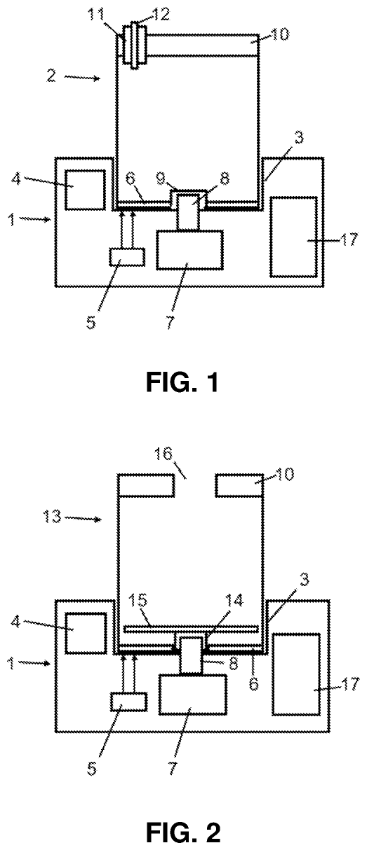

FIG. 1 shows a base unit 1 with a pressure cooker 2. The pressure cooker 2 is inserted into a recess 3 of the base unit 1. The base unit 1 comprises a control device 4 with which the preparation of a food product can be controlled. The base unit comprises a power supply device 5, via which electrical power can be supplied to an integrated heater 6 in the pressure cooker 2. The control device 4 can control the supply of electricity through the electricity supply device 5. The base unit 1 comprises an electric motor 7 having a shaft 8 extending into the recess 3. The pressure cooker 2 comprises a recess 9 on its underside into which the shaft 8 extends when the pressure cooker 2 is inserted into the recess 3. The pressure cooker 2 comprises a lid 10 attached in a pressure-resistant manner. The lid 10 is removably attached. In the lid 10, there is a valve 11 with a pin 12. The pin 12 is moved upwards and/or downwards depending on the pressure prevailing in the pressure cooker 2. Thus, the pressure in the pressure cooker 2 can be indicated. In addition, the valve 11 opens if an excessively high pressure occurs in the pressure cooker 2. An unacceptably high pressure in the pressure cooker 2 can thus be avoided.

However, the pressure cooker 2 shown in FIG. 1 may also comprise a mixing and/or cutting tool, as shown in FIG. 2 described below for a second preparation vessel.

FIG. 2 shows the base unit 1 with a second preparation vessel 13. The second preparation vessel 13 is inserted into the recess 3 of the base unit 1. Via the power supply device 5, electric power can be supplied to the integrated heater 6 in the second preparation vessel 13. The shaft 8 extends into the second preparation vessel 13. The second preparation vessel 13 comprises a shaft 14 with a mixing and/or cutting tool 15 attached thereto. The shaft 8 has been connected to the shaft 14 of the second preparation vessel 13 in a rotationally fixed manner. The electric motor 8 can therefore drive the mixing and/or cutting tool 15. The rotational speed of the electric motor 8 and thus the rotational speed of the mixing and/or cutting tool 15 can be controlled by the control device 5.

The lid 10 of the second preparation vessel 13 may have an opening 16 through which ingredients can be added to the second preparation vessel 13 even during preparation of a food product.

The base unit may have a touch-sensitive display 17 as a user interface. Inputs can be made via the touch-sensitive display 17. The kitchen appliance can output information to a user via the touch-sensitive display 17.

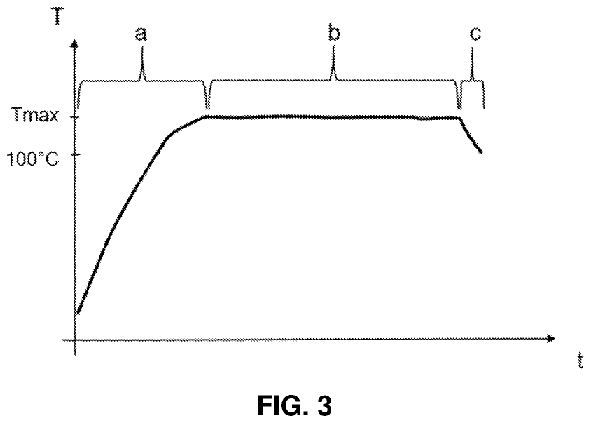

FIG. 3 illustrates a first controlled preparation of a food product in the pressure cooker 2. Temperature T is plotted versus time t. First, the temperature in the pressure cooker 2 increases during a time period a until the maximum temperature Tmax and thus also the maximum pressure pmax is reached in the pressure cooker 2. During time period b, the maximum temperature Tmax is maintained. The food product in the pressure cooker 2 has been completely cooked in time period b. Cooking of the food product has therefore finished and as quickly as possible. The pressure cooker 2 is now vented via valve 11 and thus brought to atmospheric pressure at maximum speed. The lid 10 of the pressure cooker 2 can then be removed and the food product can be removed. The pressure cooker can always be inserted in the recess 3 of the base unit 1 during this preparation. The pressure cooker 2 therefore never has to be separated from the base unit 1.

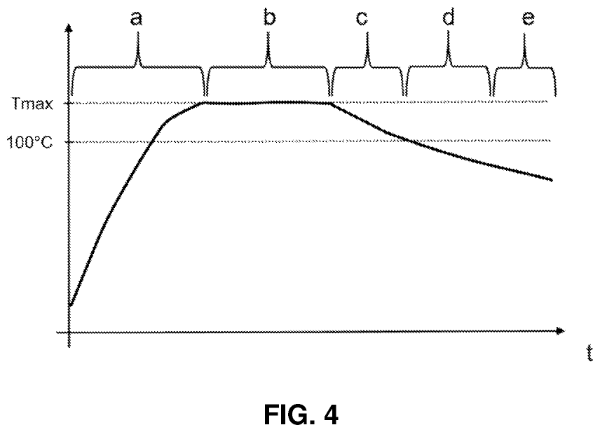

FIG. 4 illustrates a second controlled preparation of a food product in the pressure cooker 2. Temperature T is plotted against time t. First, the temperature in the pressure cooker 2 increases during a time period a until the maximum temperature Tmax and thus also the maximum pressure pmax is reached in the pressure cooker 2. During time period b, the maximum temperature Tmax is maintained. Following time period b, the pressure cooker 2 is separated from the base unit 1 and therefore no longer actively heated. The food product in pressure cooker 2 has not yet finished cooking. A time period c now follows. Time period c ends when atmospheric pressure is reached in the pressure cooker 2 due to cooling. The control device has controlled the disconnection of the pressure cooker 2 from the base unit 1 so that the food product has finished cooking after the end of time period c has been reached. The user can recognize the end of the cooking period, for example, by the pin 12 indicating that the atmospheric pressure has been reached. The pressure cooker 2 may be configured such that the lid 10 cannot be released until atmospheric pressure is reached. In this embodiment, the user is advantageously prevented from removing the lid 10 before the end of the cooking time, thereby ending the cooking prematurely. The user can thus then recognize the end of the cooking time by the fact that the lid 10 can be removed.

Once the end of time period c has been reached, the lid 10 can be removed from the pressure cooker 2 immediately and the then optimally prepared food product can be eaten or further processed. However, the food product can remain in the pressure cooker 2 for a time period d without being overcooked. However, if the time period e is reached, the food product has been overcooked in the pressure cooker 2. The food product should therefore be removed from the pressure cooker 2 and eaten before the time period e is reached, for example.

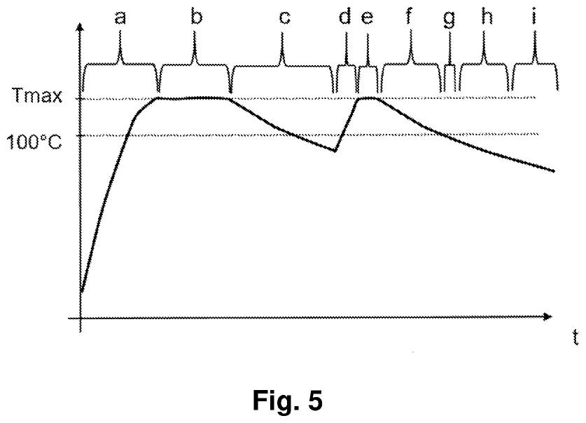

FIG. 5 illustrates a third controlled preparation of a food product in the pressure cooker 2. Temperature T is plotted against time t. First, the temperature in the pressure cooker 2 increases during a time period a until the maximum temperature Tmax and thus also the maximum pressure pmax is reached in the pressure cooker 2. During time period b, the maximum temperature Tmax is maintained. Following time period b, the pressure cooker 2 is separated from the base unit 1 and therefore no longer actively heated. The food product in pressure cooker 2 has not yet finished cooking. A time period c now follows. Within time period c, the pressure cooker 2 cools down to below 100° C. Complete preparation by passive further cooking is not possible. The pressure cooker 2 is therefore reinserted in the recess 3 of the base unit 1. The pressure cooker 2 is brought back to maximum temperature within the time period d. The maximum temperature is then maintained for a time period e. The pressure cooker is then separated from the base unit 1 again for passive further cooking. A time period f which follows time period e ends when atmospheric pressure is reached in the pressure cooker 2 by cooling. However, a subsequent time period g is still required to finish cooking the food product. The food product can now remain in the pressure cooker 2 for a time period h without being overcooked. However, if the time period i is reached, the food product has been overcooked in the pressure cooker 2. The food product should therefore be removed from the pressure cooker 2 and eaten before the time period i is reached, for example.

This control of the preparation time has the advantage that several time periods are available to use the base unit for other purposes. The time periods f and h available for a final passive further cooking is also particularly long. However, it is then more difficult for the user to detect the end of the cooking time. In particular in such a case, the control device 4 may be configured such that it informs the user that the end of the cooking time has been reached, for example acoustically and/or visually via a display. This may comprise sending a notification to a cell phone of the user.

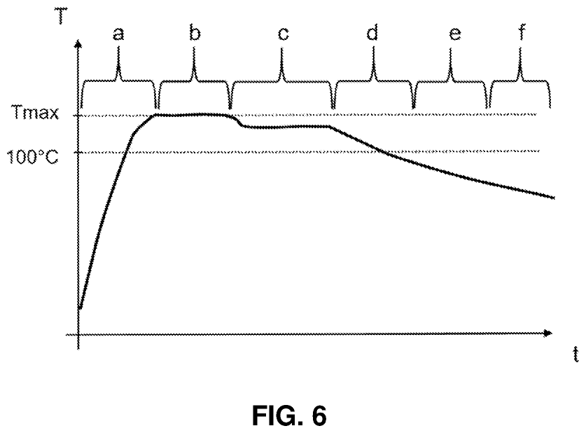

FIG. 6 illustrates a fourth controlled preparation of a food product in the pressure cooker 2. Temperature T is plotted versus time t. First, the temperature in the pressure cooker 2 increases during a time period a until the maximum temperature Tmax and thus also the maximum pressure pmax is reached in the pressure cooker 2. During time period b, the maximum temperature is maintained. Following the time period b, the control device 4 controls the power supply device 5 in such a way that the supply of power to the integrated heater 6 is reduced. The temperature in the pressure cooker 2 decreases. Through this power reduction, the temperature in the pressure cooker still remains above 100° C. However, the maximum possible temperature Tmax is no longer reached. This means that a food product in the pressure cooker is no longer cooked and therefore prepared as quickly as possible. This temperature is maintained in time period c. Following the time period c, the control device 4 switches off the power supply device 5 before the end of the cooking time. The integrated heater 6 therefore no longer heats the pressure cooker 2. A time period d now follows. Cooking of the food product is completed within the time period d. The pressure cooker 2 cools to below 100° C. during time period d. The food product can now remain in the pressure cooker 2 for a time period e without being overcooked.

However, if the time period f is reached, the food product has been overcooked in the pressure cooker 2. The food product should therefore be removed from the pressure cooker 2 and eaten before reaching the time period f, for example.

FIG. 6 shows a possible control to complete a food product at a desired time that ends after the fastest possible time. For example, a user may have set a longer preparation time than the time period b ended. In response to this change, the control device 4 may have first turned off the temperature and then completely terminated the power to the heater 6 after the time period c ended to delay the preparation of the food product.

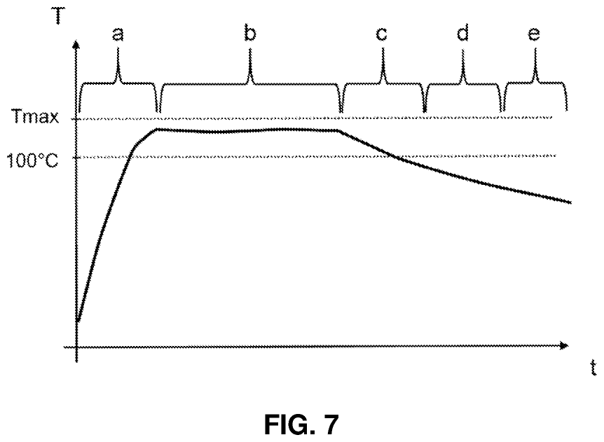

FIG. 7 illustrates a fifth controlled preparation of a food product in the pressure cooker 2. Plotted is temperature T versus time t. First, the temperature in the pressure cooker 2 rises during a time period a until a temperature is reached which is more than 100° C. However, the maximum possible temperature Tmax and thus the maximum pressure pmax are not reached in the pressure cooker 2. During time period b, the temperature is maintained. Following time period b, the control device 4 switches off the power supply device 5 before the end of the cooking time. The integrated heater 6 therefore no longer heats the pressure cooker 2. A time period c now follows. Cooking of the food product is finished within the time period c. During time period c, the pressure cooker 2 cools down to below 100° C. The food product can now remain in the pressure cooker 2 for a time period d without being overcooked. However, if time period e is reached, the food product has been overcooked in the pressure cooker 2. The food product should therefore be removed from the pressure cooker 2 and eaten before reaching time period e, for example.

FIG. 7 shows a possible control to complete a food product at a desired time which ends after the fastest possible time. For example, a user may have set a longer preparation time from the beginning. In response to this setting, the control device 4 may have initially set a temperature below the maximum possible temperature and, after the time period b has elapsed, may have completely terminated the power supply to the heater 6 to achieve the desired cooking time.

The present disclosure allows various strategies for preparing a food. If preparation is to be performed as quickly as possible, then the pressure is maximized during preparation in the pressure cooker. If preparation is to be performed as slowly as possible, then the temperature is kept low. The temperatures can then be between 75° C. and 100° C., for example. Speeds can be set that are between the maximum and minimum possible speed. If a speed is desired that is close to the maximum possible speed, then the preparation time can be slightly extended and/or the temperature can be temporarily lowered during preparation, through for example automatically switching off the heating or heating device towards the end of preparation. If a speed is desired which is close to the minimum possible speed, a low overpressure can be set in the pressure cooker and/or the heating device can be switched off relatively early, for example in an automated manner.

If the components of a meal are to be finished at the same time, for example a risotto and a salad, then the risotto can be prepared in the pressure cooker. The pressure cooker can be removed from the base unit before the end of preparation in order to continue cooking and cooling. During this cooling time, the salad can be prepared with another preparation vessel and the base unit. This strategy also applies to other food products, especially in the case where one of the components can be prepared quickly and with a small number of steps and another component requires significantly more time.

However, during the preparation of risotto or another food product with a long preparation time, the pressure cooker can be removed from the base unit several times and reconnected to the base unit in order to be able to use the base unit several times for the preparation of other components at different times. This strategy applies especially in the case where many additional steps are required for the preparation of one or more other components.

Food products are prepared by the systems and methods described herein, for example, as follows.

A food product such as goulash soup is to be produced in the pressure cooker.

When a user selects that the goulash soup is to be produced as quickly as possible, the maximum possible temperature is selected by the control device and, in one embodiment, set in an automated manner. The user may alternatively receive instructions from the control device to manually set the selected temperature. The pressure in the pressure cooker is thus maximized. When the end of the cooking time is reached, the control device may signal this, for example, acoustically and/or visually.

If a user selects that the goulash soup should be produced as slowly as possible, a minimum provided temperature is selected by the control device. In the case of goulash, this may be 100° C., for example. However, in the case of another food product suitable for this purpose, the temperature can be as low as 75° C. Thus, a minimum temperature is usually between 75° C. and 100° C.

If a user selects that the goulash soup be produced within a time that is between the minimum and maximum possible times, then a maximum provided temperature may be selected by the control device initially, or a temperature that is between the maximum and minimum possible temperatures. At a later time, the control device can either reduce the temperature or stop heating the pressure cooker. Alternatively, the control device can first reduce the temperature at a later point in time and then stop heating the pressure cooker.

If a user selects that the goulash soup should be produced within a time that is close to the minimum possible time, then a maximum provided temperature can be selected by the control device first. At a later time, the control device can stop heating the pressure cooker. If a user selects a longer time during preparation, then the control device may initially reduce the temperature at an appropriate time.

If a user selects that the goulash soup be produced within a time that is close to the maximum possible time, then the control device may initially select a temperature that is between the minimum possible temperature and the maximum possible temperature. At a later time, the control device can stop heating the pressure cooker. If a user selects a longer time during preparation, then the control device may initially reduce the temperature at an appropriate time. If a user selects a shorter time during preparation, the control device may initially increase the temperature at an appropriate time.

For example, a meal is to be prepared that comprises multiple food products. The food products of the meal are to be finished at the same time. A base unit is provided for operating the pressure cooker and for operating a second preparation vessel. The second preparation vessel comprises a mixing and cutting tool. For example, a risotto and a salad are to be prepared. The control device can now control the preparation as follows. First, the risotto is prepared in the pressure cooker at the maximum possible temperature. At a given time before the end of the cooking time, the pressure cooker is removed from the base unit. The second preparation vessel and the base unit are used to prepare the salad by chopping and mixing salad ingredients in the second preparation vessel, if necessary. The control device controls the preparation so that when the salad is completed, the risotto is completely cooked and warm. The risotto is therefore neither overcooked nor undercooked. If the salad is to be lukewarm, for example, the control device controls the temperature in the second preparation vessel accordingly.

For the preparation of a meal, it can also be provided that the pressure cooker is temporarily separated from the base unit in order to be able to use the base unit for other purposes also in the meantime. This is typically the case when a large number of steps have to be performed and/or the second preparation vessel is required for a relatively long time. In the case of bowl recipes (“colorful bowl dishes”, “mixed bowl dishes”), this may be necessary.

The temperatures as well as the termination of the heating can be set in an automated manner by the control device. The user may alternatively receive instructions from the control device to manually set the selected temperatures, for example, to turn off a heater provided for heating or to disconnect the pressure cooker from a base unit, thereby terminating heating. When the end of the cooking time is reached, the control device may signal this, for example, audibly and/or visually. This may comprise sending a notification to a cellphone of the user.

The present disclosure enables automated selection of a strategy to meet predetermined cooking times (completion time point/window). A user can be guided to ensure success of a preparation. The preparation of multiple food products can be synchronized in an automated manner. Within certain limits, desired cooking times can be maintained in an automated manner.

The present disclosure enables energy-efficient cooking. Residual heat can be used optimally. The comfort for a user is improved.

1. A food preparation system, the system comprising
a kitchen appliance for preparing a food product,
a control device, and
a device for selecting a preparation time for food products,
wherein the control device is configured such that it is able to control the preparation of a food product such that a selected preparation time is observed.

2. The system of claim 1, wherein the system comprises a device for inputting a food product and a memory on which is stored a database with electronically stored information on cooking times of food products depending on temperature and/or quantity for controlling the preparation of the food product.

3. The system of claim 1, wherein the control device is configured such that controlling the preparation of a food product comprises issuing an instruction to a user.

4. The system of claim 3, wherein an instruction to a user comprises that a preparation vessel of the kitchen appliance is to be removed from a base unit of the kitchen appliance.

5. The system of claim 1, wherein the kitchen appliance is a pressure cooker or comprises a pressure cooker.

6. The system of claim 5, wherein a heating device is integrated in the pressure cooker.

7. The system of claim 5, wherein the control device is configured such that it controls the preparation of a food product in such a way that a food product in the pressure cooker is initially prepared at the maximum possible temperature and, at a later time, the pressure cooker is separated from a base unit over which the pressure cooker is heated.

8. The system of claim 6, wherein the control device is configured such that it controls the preparation of a food product in such a way that a food product in the pressure cooker is initially prepared at the maximum possible temperature and, at a later time, the pressure cooker is separated from a base unit over which the pressure cooker is heated.

9. A method for preparing a food product, the method comprising
providing a food preparation system, the system comprising
a kitchen appliance for preparing a food product,
a control device, and
a device for selecting a preparation time for food products,
wherein the control device is configured such that it is able to control the preparation of a food product such that a selected preparation time is observed, and
selecting a preparation time via the device, wherein the control devicecontrols the preparation of the food product such that the selected preparation time is observed.

10. The method of claim 9, wherein a food product is input by means of the device for inputting a food product of the system and that the system selects the input food product from the database with the electronically stored information on cooking times of food products and controls the preparation of the food product by means of the information of the food product in such a way that the selected preparation time is observed.

11. The method of claim 9, wherein, as part of the preparation of the food product, an instruction for a user is output visually via a display, another visual element and/or acoustically via a loudspeaker.

12. The method of claim 11, wherein the supply of heat to the food product is switched off before the end of the cooking time.

13. The method of claim 12, wherein the preparation vessel of the kitchen appliance is removed from a base unit of the kitchen appliance before the end of the cooking time.

14. The method of claim 9, wherein the kitchen appliance is a pressure cooker and heat is supplied to the pressure cooker by means of a base unit.

15. The method of claim 14, wherein a food product is initially prepared in the pressure cooker at the maximum possible temperature and at a later time the pressure cooker is separated from the base unit before the end of the cooking time.

16. The method of claim 15, wherein, after the pressure cooker has been separated from the base unit, a further food product is prepared using a different preparation vessel and the base unit.

17. The method of claim 9, wherein the kitchen appliance of the food preparation system is a pressure cooker or comprises a pressure cooker.

18. The method of claim 17, wherein a heating device is integrated in the pressure cooker.

19. The method of claim 17, wherein the control device is configured such that it controls the preparation of a food product in such a way that a food product in the pressure cooker is initially prepared at the maximum possible temperature and, at a later time, the pressure cooker is separated from a base unit over which the pressure cooker is heated.

20. The method of claim 18, wherein the control device is configured such that it controls the preparation of a food product in such a way that a food product in the pressure cooker is initially prepared at the maximum possible temperature and, at a later time, the pressure cooker is separated from a base unit over which the pressure cooker is heated.
